(19) United States
(12) Patent Application Publication
(10) Pub. No.: US 2010/0250282 A1
(43) Pub. Date: Sep. 30, 2010

(54) CUSTOM ORDER SETS

(75) Inventor: Christopher David Johnson, San Francisco, CA (US)

Correspondence Address: Beyer Law Group LLP, P.O. BOX 1687, Cupertino, CA, 95015-1687, US

(73) Assignee: STEPPING STONE CLINICAL SYSTEMS, LLC, San Francisco, CA (US)

(21) Appl. No.: 12/730,949

(22) Filed: Mar. 24, 2010

Related U.S. Application Data
(60) Provisional application No. 61/162,891, filed on Mar. 24, 2009.

(51) Int. Cl. G06Q 50/00; G06F 17/30

(52) U.S. Cl. 705/3; 707/805; 707/E17.044

(57) ABSTRACT

Custom Order Sets for use by doctors and clinicians allow the user to utilize Order Sets and Orderables in clinical encounters. Closed-loop processes and systems for creating a Custom Order Set and using the Order Set to get feedback from Physicians and make modifications to Orderables and Order Sets used in a hospital are described. A Physician can create her own Order Sets and submit them to the hospital for approval. If approved, they can be included in the hospital's Order Sets Library and used by other Physicians. A Physician can create a Framework of Order Sets. A Framework is intended to reflect how the Physician organizes clinical knowledge in her specialty and is intended to match the way the Physician thinks about a Clinical Encounter with a patient. The Physician selects Order Sets from categories within the Framework. These Order Sets are organized or blended together using a detailed process to form a Custom Order Set. A Custom Order Set provides a visual display of Order Sets based on Views and categories and provides various types of information by way of visual markups and text. The Physician can provide Feedback at several levels, such as at the Order Set or Orderable levels or make requests for new content.

### CROSS-REFERENCE TO RELATED APPLICATIONS

This application claims the benefit under 35 U.S.C. Section 119 of U.S. Provisional Patent Application No. 61/162,891, titled “System for Integrating Order Sets, Orderables, Physicians and Quality Measures”, filed Mar. 24, 2009, which is hereby incorporated by reference in its entirety.

### FIELD OF THE INVENTION

The present invention generally relates to medical and hospital computer information systems. More specifically, it relates to computer systems and methods for use by physicians in treating patients and to tools for analyzing physician practice.

### BACKGROUND OF THE INVENTION

There has been an increasing need to reduce medical errors in hospitals and clinics. Responding to public concern over such errors, and seeking to standardize care around best practices to control quality and cost, hospitals are purchasing costly clinical information systems installed with a technology known in the industry as Computerized Physician Order Entry (CPOE). Current estimates are that 10% of US hospitals have CPOE systems and the number is expected to grow significantly in the next few years.

However, CPOE systems require a certain type of structured data to operate successfully. Manual entry of this data in the required format has proven very impracticable for busy healthcare professionals (hereinafter “physicians”) in the front-lines. Thus, the success of these systems has relied heavily upon pre-built templates referred to as order sets, a term known in the field of medical/hospital software development. Order sets, described in greater detail below, essentially offer templates of care for the most common diagnoses and procedures. Utilizing a checklist approach, they allow physicians to rapidly select the appropriate options for care in a structured data format. Order sets are critical to successful implementation of CPOE systems and are currently delivered to physicians through two mechanisms.

First, they can be pre-printed documents or “printed-on-demand” at the time of use. This creates a paper order set that is completed by hand. These paper order sets have demonstrated benefits for patient care through a “checklist effect”, reducing errors of omission and errors of commission through passive guidance to the physician. However, paper order sets cannot offer alerts or other sophisticated decision support. Furthermore, analyzing the patterns of clinical practice from paper order sets is extremely time-consuming for the hospital, requiring laborious manual chart reviews by trained Health Information Management personnel to extract and aggregate the relevant data.

Alternately, order sets may be delivered electronically as part of a Computerized Physician Order Entry (CPOE) system. CPOE systems can maintain libraries of hundreds of order sets and include active decision support and analytical tools for better understanding clinical practice. For example, a CPOE system can actively check an order set for deficiencies or potential safety concerns, and trigger an alert before the physician that requires a response to proceed. CPOE also allows for much easier aggregation and analysis of practice patterns to identify opportunities for improvements in patient care.

Current CPOE systems have two major deficiencies. First, making “front-end” changes to order sets or decision support rules can be exceedingly complex and costly. These objects often require a network of dedicated IT personnel to make modifications. Furthermore, it is often difficult and expensive to adapt order sets or decision support to local clinical practice at a particular institution. Second, similar challenges arise with the “back-end” analytical tools available in most current CPOE systems. They require extensive training to use and often do not include useful analytical reports that can easily be used by the typical staff available in a typical community hospital. Creating or modifying an analytical report can take weeks to months and cost thousands of dollars of staff time.

Thus, it would be desirable to have systems that can deliver order sets to physicians, but also integrate decision support and analytical reports in closed-loop processes that can be easily operated and modified by the staff available at a typical community hospital.

### SUMMARY OF THE INVENTION

To achieve the foregoing, and in accordance with the purpose of the present invention, closed-loop processes and systems for creating a Custom Order Set and using the Order Set to get feedback from Physicians and make modifications to Orderables and Order Sets used in a hospital are described. A Physician can create her own Order Sets and submit them to the hospital for approval. If approved, they can be included in the hospital's Order Sets Library and used by other Physicians. A Physician can create a Framework of Order Sets. A Framework is intended to reflect how the Physician organizes clinical knowledge in her specialty and is intended to match the way the Physician thinks about a Clinical Encounter with a patient. The Physician selects Order Sets from categories within the Framework. These categories may be described as conceptual groups of Order Sets for a Physician in a particular specialty. These Order Sets are organized or blended together using a detailed process to form a Custom Order Set. A Custom Order Set provides a visual display of Order Sets based on Views and categories and provides various types of information by way of visual markups and text. The Physician can provide Feedback at several levels, such as at the Order Set or Orderable levels or make requests for new content.

The hospital or clinic can collect data on the usage of Orderables and Order Sets and use this data to analyze performance and make modifications to the Order Sets Library. By setting thresholds of utilization, the hospital can automatically determine which Orderables in an Order Set should be pre-selected (selected by default), which should be removed because of low usage, and which ones can be upgraded or downgraded, all based on utilization data collected by the system. Once the data has been analyzed, either automatically or manually, and modifications have been made to the Order Sets, they are delivered to the Physicians, through Frameworks and Custom Order Sets. In this manner, a closed-loop process: Delivery to Feedback to Analysis to Modification and back to Delivery, is enabled.

### BRIEF DESCRIPTION OF THE DRAWINGS

The invention, together with further advantages thereof, may best be understood by reference to the following description taken in conjunction with the accompanying drawings in which:

FIG. 1 is a flow diagram showing a closed-loop process of creating and maintaining custom order sets in accordance with one embodiment of the present invention;

FIGS. 2A to 2E are diagrams showing various features of Order Sets in accordance with various embodiments of the present invention;

FIG. 3 is a diagram showing the relationship between Quality Measures and Orderables;

FIG. 4A is a diagram showing an approval process for Physician Order Sets in accordance with one embodiment;

FIG. 4B is a diagram showing the composition of an Order Sets Library;

FIG. 5 is a diagram showing an example of a Framework in accordance with one embodiment;

FIGS. 6A and 6B are flow diagrams showing how Order Sets are organized and “blended” to create a Custom Order Set in accordance with one embodiment;

FIG. 7 is a diagram showing possible Analytical Reports;

FIG. 8 is a screenshot of a Framework display;

FIG. 9 is a screenshot of a Custom Order Set display;

FIG. 10 is a flow diagram of an automatic analysis process in accordance with one embodiment; and

FIGS. 11A and 11B illustrate a computer system suitable for implementing embodiments of the present invention.

### DETAILED DESCRIPTION OF THE INVENTION

Methods and systems for creating and using custom order sets are described in the various figures. Also described are methods and systems for using feedback on the Order Sets and other variables to improve hospital and physician performance. Throughout this description certain variables are used to describe the invention. These are Orderables, Order Sets, Quality Measures, and Physician.

Orderables are how physicians direct care inside hospitals. Orders cover the gamut of possible interventions from nursing care to diagnostics to administration of medications. An Orderable is a potential order that is presented to a Physician. By selecting and optionally modifying an Orderable, the Physician converts it into an Order that has medico-legal force. Examples of Orderables include “Aspirin 325 mg by mouth once daily” (medication orderable), “Left Ventricular Ejection Fraction not assessed due to previous assessment available in chart” (documentation orderable), and “Elevate head of bed>30 degrees” (nursing orderable).

An Order Set is a collection of Orderables along with associated instructions and reminders, typically related to a specific hospital unit or medical condition. Examples include an Intensive Care Unit (ICU) having a corresponding “ICU Admission Order Set”, while the Cardiology Department may have a “Congestive Heart Failure Order Set,” each containing a different set of medication, nursing, lab and other types of Orderables.

A Quality Measure is a goal state of the hospital that can be affected by Orderables. By selecting certain Orderables and not selecting others, a Physician can positively or negatively impact Quality Measures for the hospital. Examples include a hospital having a Quality Measure for “Time to Administration of Antibiotics in Community-Acquired Pneumonia.” The Physician's choice among antibiotic Orderables and timing of that selection will contribute positively or negatively to the hospital's performance on this Quality Measure. Finally, the term Physician refers to the individual physician user of the systems and methods of the various embodiments described below. Physician may include, more generally, other clinicians and health care providers, such as nurses.

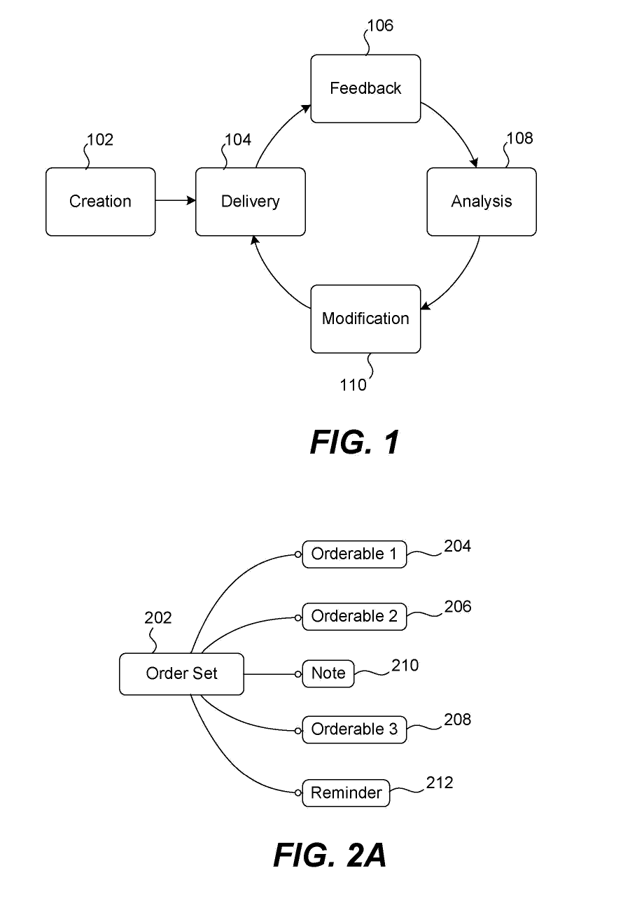

FIG. 1 is a flow diagram showing a closed-loop process of creating and maintaining custom order sets in accordance with one embodiment of the present invention. At step 102 a creation process is implemented that allows hospital content and physician content creation. The hospital content creation process is described first. In this step, hospital quality measures are created, followed by creation of hospital order sets and orderables, which may include adding classes, negation classes, and hospital quality measures.

In one embodiment, a hospital first creates their Quality Measures. The hospital defines traits of the Quality Measures and sets levels of validation. This allows decision support to be finely tailored to the local culture of the hospital. In one embodiment, a Quality Measure may have the following traits: Name, Type—lookup table defined by hospital (e.g. Quality, Safety, Revenue), Goal Value (%), Critical Value (%), and Required vs. Suggested.

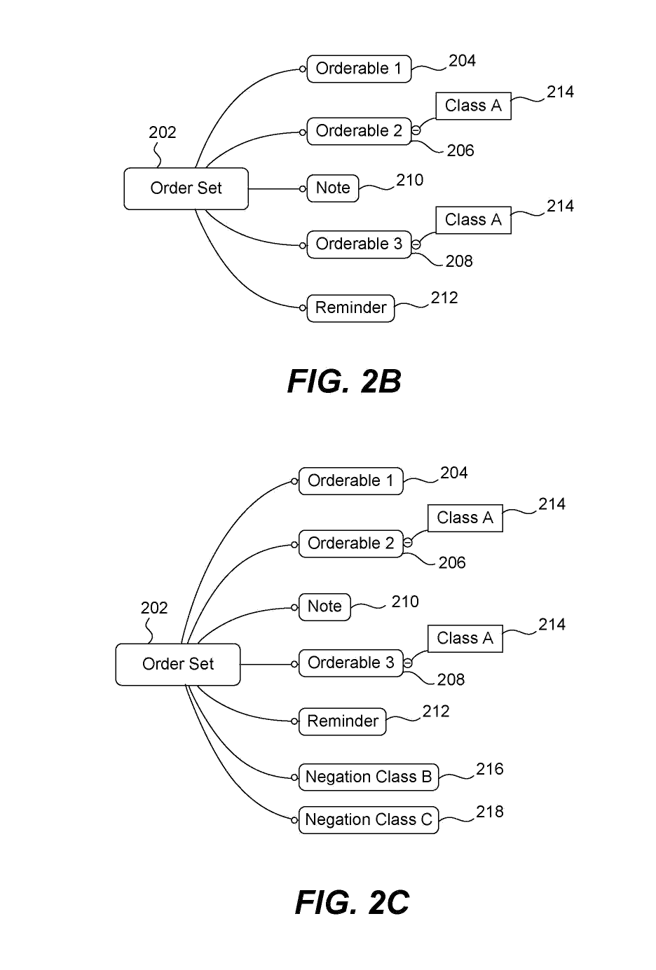

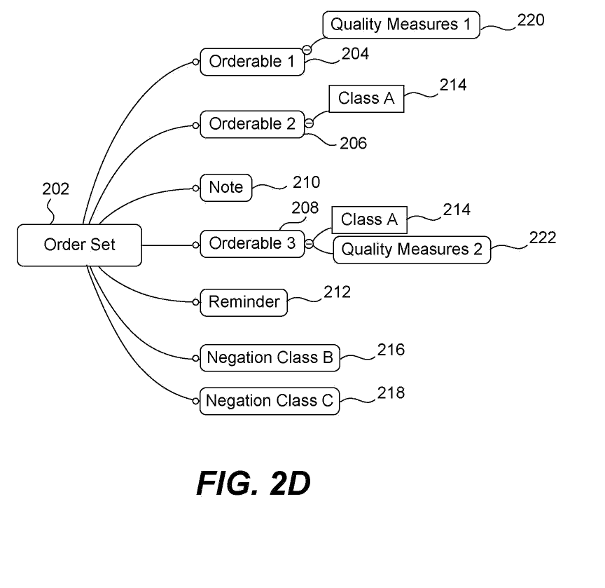

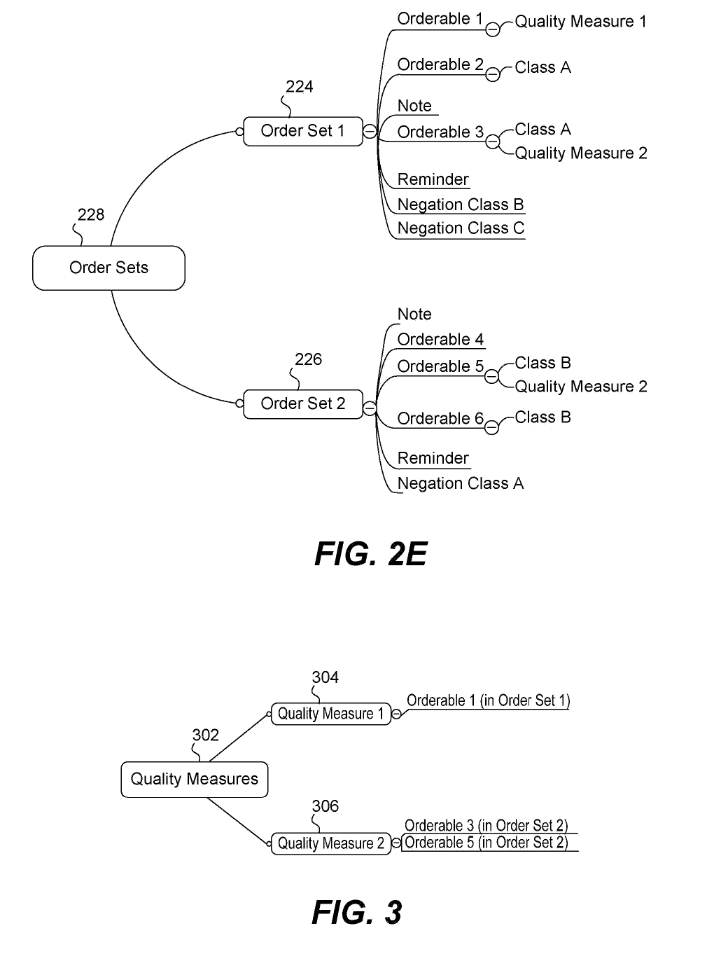

A hospital may also create or import Order Sets which, as described above, are comprised of Orderables, together with associated Notes, Reminders or other informational elements that are not classified as Orderables. This is shown in FIG. 2A. An Order Set 202 has three Orderables 204-208, a Note 210, and a Reminder 212. Classes may also be added to an orderable by having optional Classes defined for them, describing Orderables overall type or category (e.g. medication Warfarin, an Orderable, is of class Anticoagulant). This is shown in FIG. 2B which shows Class A 214 defined or attached to Orderable 206 and 208.

As described below, different order sets may be combined prior to presentation to the physician. When combining order sets, there can be interactions between Orderables [?] that can have implications for patient care. Thus, an Order Set may have pre-defined Negation Classes 216 and 218 as shown in FIG. 2C. A Negation Class is a proscribed Class of Orderables that are in other Order Sets. For example, the class “Anticoagulants” (essentially a group of Orderables having a similar property) might be set as a Negation class in a Gastrointestinal Bleed Order Set.

Having created the Order Sets, comprised of Orderables (which may or may not belong to a Class) and, optionally, Negation Classes, the hospital can then apply Hospital Quality Measures to which Orderables it believes should have one. A Quality Measure is applied to a specific Orderable rather than to an entire Order Set. This is shown in FIG. 2D. A Quality Measure 1 220 is applied to Orderable 1 204 and Quality Measure 2 222 is applied to Orderable 3 208.

At this point in step 102 (Creation process), the hospital has created multiple Hospital Order Sets (may be described as a library of Order Sets). Each Order Set may have optional Negation Classes and is composed of Orderables, each of which may have an optional Class and Quality Measure. This is shown as Order Set 1 224 and Order Set 2 226 of Order Sets 228 in FIG. 2E. The hospital will also have created Hospital Quality Measures 302 showing, for example Quality Measure 1 304 and Quality Measure 2 306. These Quality Measure have been applied to specific Orderables as shown in FIG. 3.

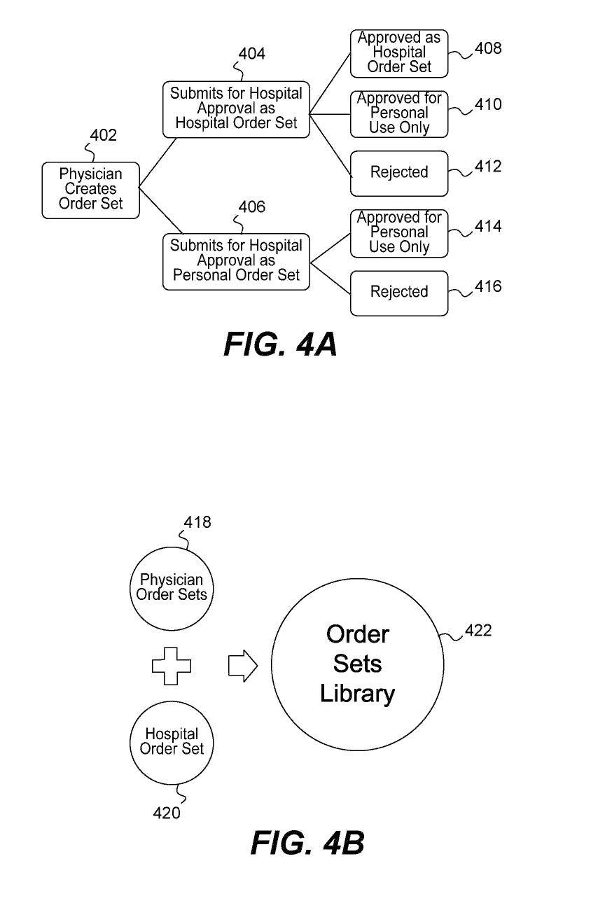

In addition to the content created by the Hospital individual Physicians can also create their own Order Sets made up of Orderables created by the Hospital or Orderables created by the Physicians (Physicians typically do not create Quality Measures). In one embodiment, this is done using Physician Order Sets. The System presents the physician with a blank Order Set template. The Physician then manually adds their Orderables to create a customized Physician Order Set. After creation of this Physician Order Set, the physician can either save it for their personal use, or submit the Order Set to the hospital for approval as a new Hospital Order Set that can be used by other Physicians. This is shown in FIG. 4A. At step 402 the Physician creates an Order Set. It is then either submitted for hospital approval as a Hospital Order Set at step 404 or submitted for approval as a Physician Order Set at step 406. The outcomes from step 404 are Approved as Hospital Order Set (408), Approved for Personal Use (410) or Rejected (412). Outcomes from step 406 are approved for personal use only (414) or rejected (416).

As noted, the physician can also define his own Orderables (e.g. nursing orderables, medication orderables). These can be combined with Hospital Order Sets (or more specifically, with Hospital Orderables), as described below. FIG. 4B shows Physician Order Set 418 and Hospital Order Set 420 combined to create an Order Set library 422. At the end of step 102, the system has a data set of the following objects: Hospital Quality Measures, Hospital Order Sets (with Hospital Orderables and Negation Classes), Hospital Orderables (wherein an Orderable may be associated with a Class or a Hospital Quality Measure), Physician Order Sets (optionally submitted for acceptance as Hospital Order Set), and Physician Orderables.

Returning now to FIG. 1, at step 104, certain order sets in library 422 are delivered to the physician. In one embodiment, there are several sub-processes that may be implemented in delivery step 104. One sub-process may be referred to as configuration. Prior to any clinical encounter between a physician and a patient, Order Sets are organized according to one or more predefined conceptual Frameworks appropriate for different Physician specialties. This is done during configuration. These Frameworks are based on the most common ways physicians in a specialty may conceptually divide up order set content. These frameworks may be developed in consultation with input from physicians and clinicians. Below are some examples of frameworks.

### Framework Example 1

### Hospitalist (Specialty, Internal Medicine)

Admit/Transfer/Discharge
Primary Problems
Hospital Care

### Framework Example 2

### Emergency Medicine (Specialty, Emergency Medicine)

ED Problem
ED Care

### Framework Example 3

### Surgery

Procedure
Comorbidities
Additional Hospital Care
   The bullet points in the above examples (e.g. Primary Problems, ED Care, Comorbidities, etc.) are conceptual groups of order sets or “categories” of order sets. In the configuration sub-process, each conceptual group is defined and then the conceptual groups are collected into frameworks. Frameworks are intended to reflect how a Physician organizes clinical knowledge in his or her specially and match or outline the way the Physician approaches a problem or thinks about how to proceed. A Physician having a specialty in Internal Medicine comes up with certain steps or stages that would normally be taken when seeing a patient (e.g., Admit to, Primary Problems, Hospital Care). A surgeon may think along the lines of Procedure, Comorbidities, Additional Hospital Care, and so on. After creating these groups, the Physician selects those Order Sets that best fit in the groups. Thus, the Order Sets are selected to be in groups that match the Physician thinks about a Clinical Encounter, described below.

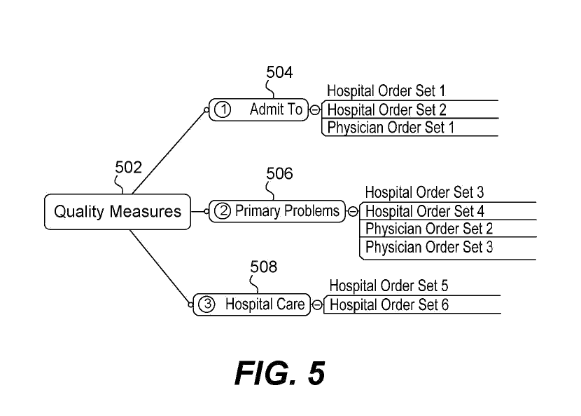

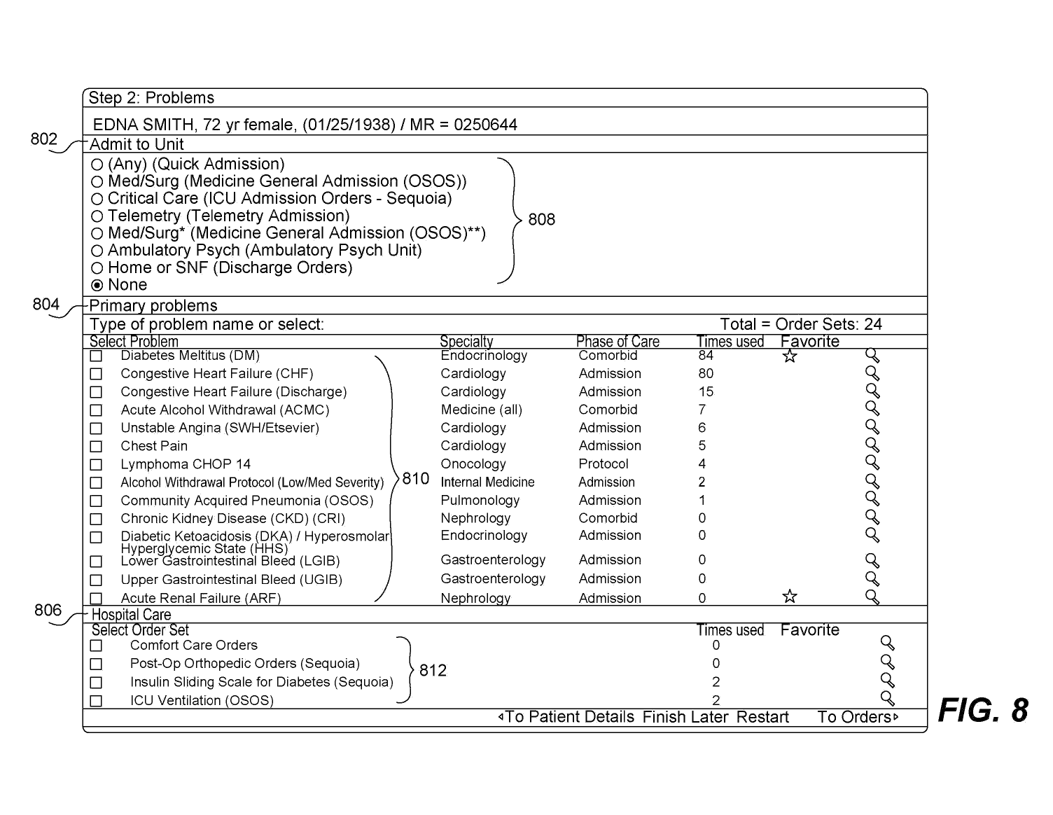

Another sub-process that occurs in step 104 is the Clinical Encounter. In a clinical encounter, the system is accessed by a Physician when consulting with a specific patient. The Physician is presented with a menu of Order Sets. This may include both Hospital Order Sets and their own Physician Order Sets. In one embodiment, this menu of Order Sets is organized using a Framework predefined for that Physician's particular specialty. An example of a Framework 502 (e.g., Hospitalist) is provided in FIG. 5. A Physician in Internal Medicine will see the Order Sets shown in FIG. 5, which may be comprised of Hospital and Physician Order Sets. The Order Set will be grouped based on conceptual groups “Admit To” 504, “Primary Problems” 506, and “Hospital Care” 508. A screenshot of this framework is shown in FIG. 8. In FIG. 8, Admit to Unit 802, Primary Problems 804, and Hospital Care 806 are the conceptual groups of Order Sets for Internal Medicine. Once the available choices are presented, shown as Order Sets 808, 810, and 812 in FIG. 8, the Physician can select one or more Order Sets that are relevant for that particular Clinical Encounter.

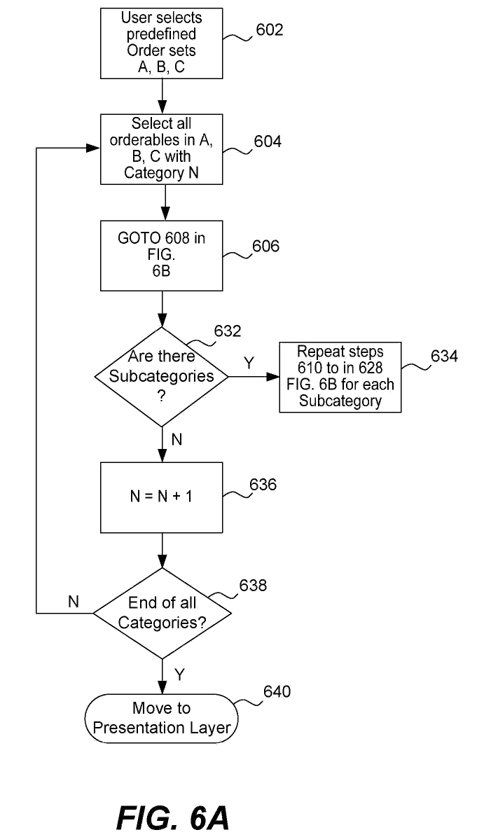

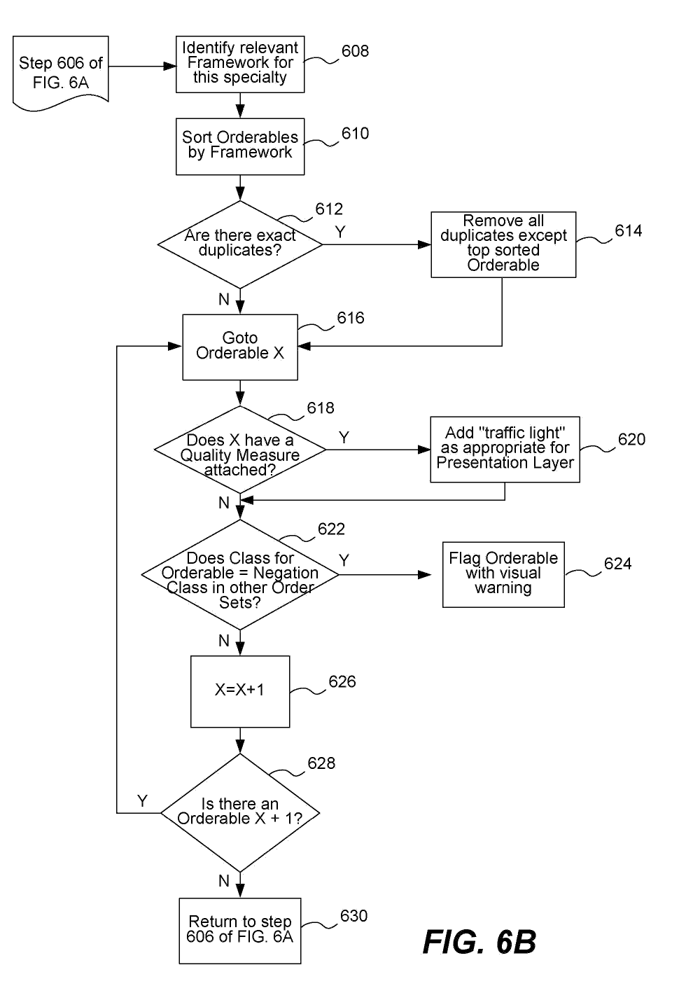

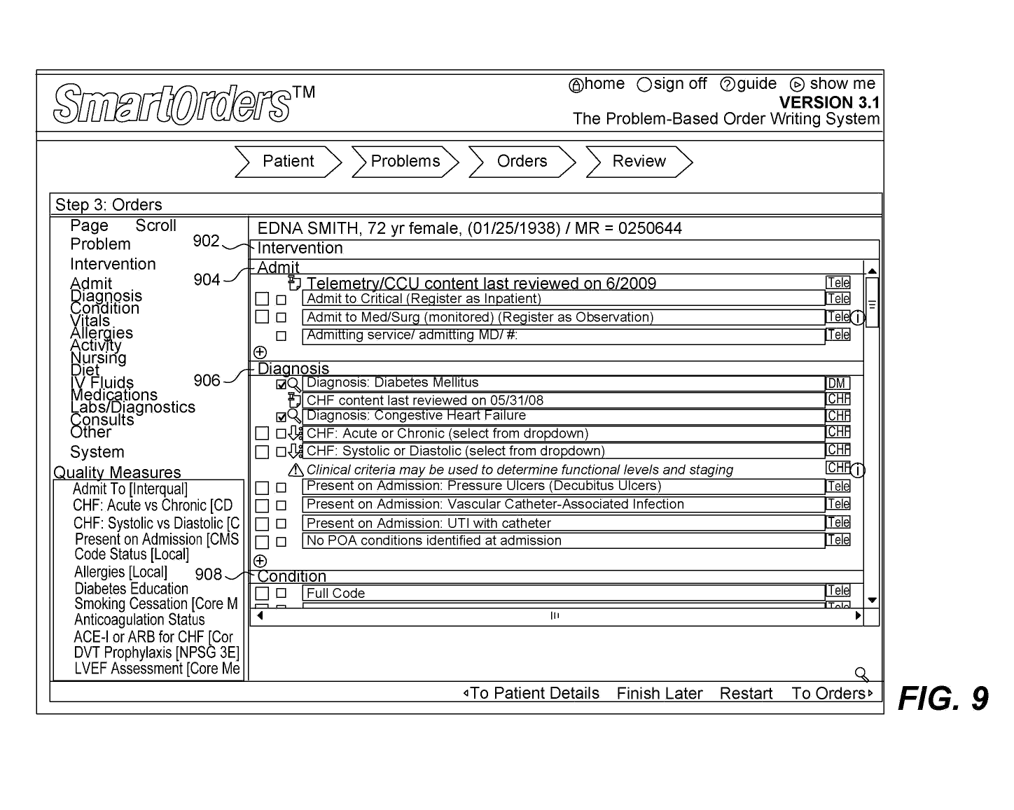

Another sub-process that occurs at step 104 is the combining of Order Sets that were selected during a Clinical Encounter into a Custom Order Set. After the Physician has selected the relevant Order Sets, they are combined or blended according to certain principles. This “blending” process to create a Custom Order Set is described in FIGS. 6A and 6B. At step 602 of FIG. 6A, a physician selects Order Sets (e.g., A, B, and C) from a Framework, such as the one shown in FIG. 8. At step 604 the system identifies all the Orderables in A, B, and C within a Category N (in the initial iteration of the process, this would be the first Category). The Category is from a particular View. Taking the Custom Order Set shown in FIG. 9 as an example, the View is Intervention 902 and the Categories are Admit 904, Diagnosis 906, and Condition 908. Admit 904 may be the first Category to be processed. At step 906, control goes to the process described in FIG. 6B.

At step 608 of FIG. 6B, the system identifies the framework for the specialty (this is the same Framework from which the physician selected the Order Sets A, B, and C in step 602). At step 610 the system sorts the Orderables by the particular Framework, creating a list of Orderables from Category N in step 604 (within the particular Framework). At step 612 the system determines if there are any exact duplicates of Orderables in list created at step 610. If there are, at step 614, the duplicates are deleted or removed keeping only the top sorted Orderable. If there are no duplicate Orderables or after duplicates have been removed, control goes to step 616 where the system retrieves or examines the first Orderable on the list, Orderable X.

At step 618 the system checks whether Orderable X has an associated Quality Measure (see FIGS. 2D and 3) attached. If it does, control goes to step 620 where the appropriate visual markup is added, such as the “traffic light” markups described above. If there is no Quality Measure or after the visual markup has been added, control goes to step 622 where the system determines whether a Class for the Orderable is equal to a Negation Class in any other Order Sets (see FIG. 2C for discussion on Class and Negation Class). If a Class for Orderable X is the same as a Negation Class, control goes to step 624 where a visual markup or warning is added to the Orderable, that is, the Orderable is flagged with a visual warning. If any class for Orderable X does not equal a Negation Class or after Orderable X is flagged, at step 626, the Orderable count is incremented by one to Orderable X+1. At step 628 the system determines whether there is an Orderable X+1 (i.e., are there any remaining Orderables?) If there are, control returns to step 616 where the process repeats for Orderable X+1. If there are no more Orderables, control returns to the process of FIG. 6A at step 630. Specifically, it returns to step 632 of FIG. 6A where the system determines whether there are any subcategories for Category N. If there are, control goes to step 634 where steps 610 to 628 are repeated for each subcategory. Thus, at step 610, a list of Orderables from the subcategory is sorted, followed by the same duplicate removal and visual markup steps that were performed for Category N.

If at step 632 the system determines that there are no subcategories, control goes to step 636 where the category count is incremented to Category N+1. At step 638 the system determines whether there is a Category N+1. If there is, control returns to step 604 where all the Orderables in Order Sets A, B, and C with Category N+1 are selected and the process is repeated. For example, Category N+1 may be Diagnosis or Condition (see Custom Order Set shown in FIG. 9). If there are no more categories, the blending process is complete and the Custom Order Set is displayed to the Physician.

At the end of the process described in FIGS. 6A and 6B, there is a single Custom Order Set that represents the combination of selected Order Sets. In this process duplicate Order Sets are removed. The Physician now sees one Order Set (the Custom Order Set) and only Orderables. FIG. 9 is a screenshot of a Custom Order Set. It shows a View, “Intervention” 902 at the top and categories Admit 904, Diagnosis 906, and Condition 908. Under each of these categories are the individual Orderables. Orderables are also flagged if they have a Class that is the same as the Negation Class from another Order Set.

As shown in FIG. 9, the Custom Order Set is now presented on a display to the physician. In one embodiment, visual “markups” for Orderables may be included. For Orderables that have a Quality Measure, the following markups may be applied: 1) Orderables with Required Quality Measures are presented with a “red traffic light” next to the Orderable (e.g., to the left of the checkbox); 2) Orderables with Suggested Quality Measures are presented with a “yellow traffic light” next to the Orderable; and 3) Quality Measures that have already been satisfied after combining (due to prechecked Orderables, etc.) are presented with a “green traffic light” next to the Orderable. In other embodiments, different visual indicators may be used or such visual indicators may not be used.

For Negation Classes, the following visual markups may be applied. If an Orderable has a Class that is equal to a Negation Class from another Order Set, the Orderable is highlighted with a warning flag, including an explanation of the conflict. For example, combining an Upper Gastrointestinal Bleed Order Set, which has a Negation Class=Anticoagulants, with an Acute Coronary Syndrome Order Set having an Orderable for Heparin (a medication of the Anticoagulant class) would cause the Heparin orderables to be highlighted with an explanation of the conflict with Upper Gastrointestinal Bleed. There may also be markups for subcategory classes. For example, if an Orderable, such as Precheck=Null, Negation Warning Flag=Null AND Quality Measure=Null, then the Orderable is hidden in a dropdown for that Subcategory.

The final visual product on the display is a “Custom Order Set” which may have numerous features. As noted, a Custom Order Set is organized in Categories or Views (e.g., Intervention). Each Category contains Orderables which were blended from multiple Order Sets. The Orderables are rank-ordered by appropriate Framework for Physician specialty. Orderables with Quality Measures have “red”, “yellow” or “green” traffic lights as appropriate. Orderables with Negation Class conflicts have warning flags with explanations. Orderables that are not pre-checked and have no flags or traffic lights are hidden in a drop-down menu (which can be accessed by clicking the “+” sign at the bottom each category (see FIG. 9).

With the Custom Order Set displayed on the screen, the Physician may now reorganize the content of the Custom Order Set as needed using a user interface. This reorganization may be based on PROBLEM/INTERVENTION/SYSTEM as described in U.S. patent application Ser. No. 11/969,133, titled “Order Sets Having Different Views for CPOE Systems,” filed Jan. 3, 2008, incorporated by reference for all purposes. A SCROLL/PAGE VIEW technique may also be used where “Scroll” enables presentation of all Order Set Categories or Views sequentially in a single scroll view and “Page” enables presentation of only those Orderables in a given Category on a page. Physician selects Next or Previous Category to show pages of Orderables from the Custom Order Set. These options allow the Physician to further customize the view to their particular preferences given the needs of the clinical scenario and the Order Sets chosen.

At step 106 of FIG. 1 the physician may leave feedback with respect to the Custom Order Set being used by the physician. At one level, the physician may enter subjective feedback on any of the Order Sets used in the creation of the Custom Order Set (see FIG. 8). For example, the Physician may point out gaps in the Orderables available for the Upper Gastrointestinal Bleed Order Set. At another level, the Physician may leave subjective feedback on any of the specific Orderables in the Custom Order Set (see FIG. 9). For example, the Physician can identify dangerous medications or necessary changes in dosing route or dose strength. At yet another level, the Physician can also leave a request for New Content (new Order Set), identifying gaps at the level of the Order Sets themselves. For example, the Physician may identify that for a particular clinical scenario, the current Order Sets and Orderables are fine, but that there is also a need for a new Order Set called “Dehydration”. This subjective feedback is captured, linked and indexed at the same level at which the Physician entered the feedback, that is, Order Sets, Orderables or New Content Request. In other embodiments, a Physician may enter feedback at other levels not listed above.

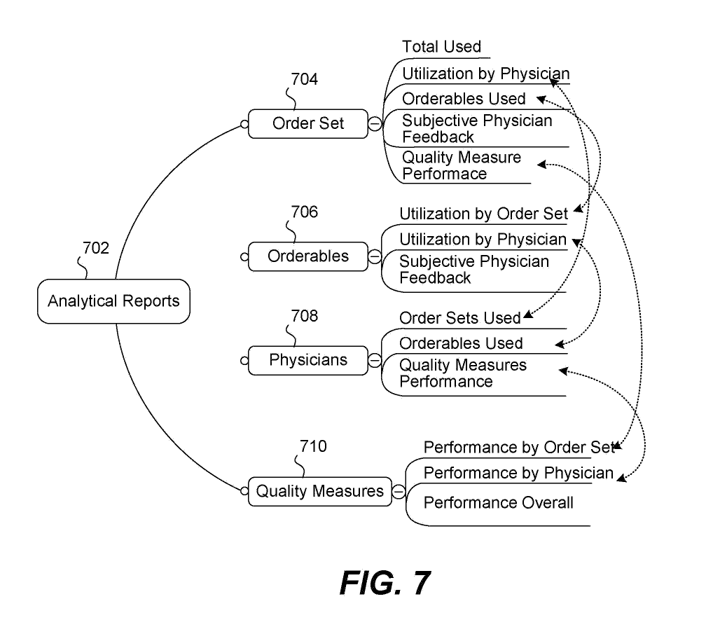

At step 108 of FIG. 1, the analysis phase begins. For example, reports may be generated from completed Custom Order Sets (stored in a database). All associated information relating to the Order Sets, Orderables, Quality Measures, Physicians and Feedback are also captured and stored. Using this stored data, reports can be run on any of the four critical variables: Order Sets, Quality Measures, Physicians, and Orderables. These reports may have elements and interlocking relationships as shown in FIG. 7. Analytical reports 702 may include reports on Order Set 704, Orderables 706, Physicians 708, and Quality Measures 710. Some possible interlocking relationships are shown by the arrows. Examples of the kinds of information gathered using a Framework (see e.g., FIG. 5) may include: 1) Admitting diagnoses and co-morbid conditions; 2) Where within the hospital the patient is admitted or transferred (e.g. observation, floor, telemetry. ICU); 3) Treating physician; 4) All ordered lab tests at transitions of care or significant interventions (procedures, pre-op preparation, etc.); 5) All ordered imaging tests at transitions of care or significant interventions (procedures, pre-op preparation, etc.); 6) All ordered medications at transitions of care or significant interventions (procedures, pre-op preparation, etc.); and 7) All ordered ancillary care interventions at transitions of care or significant interventions (procedures, pre-op preparation, etc.).

One advantage of analytical reports 702 and the underlying data model described above is the opportunity for a hospital to improve care at key “transitions of care” points. Admission to a hospital, transfers between hospital units and/or discharges from an institution are all classic scenarios for order set use and are examples of “transitions of care”. These “transitions of care” are also major points in the current healthcare delivery system where medical errors and suboptimal quality can occur. Thus, a system that delivers order sets at these critical points and aggregates the above data about medical and nursing interventions at these key transitions can potentially have a significant impact on improving patient care.

At the last step of FIG. 1, step 110, the hospital may use the analysis and reports from step 108 to modify Order Sets or procedures in the hospital to improve care. A major challenge for small and medium-sized hospitals with limited staff resources is turning the analysis described in step 108 into action. Even when analytical tools are available, it is often unclear what the appropriate action should be to improve care. The embodiments of the present invention attempt to ease this process by automatically identifying opportunities for care improvement in several of the key variables (i.e., Order Sets, Orderables, Quality Measures, and Physicians).

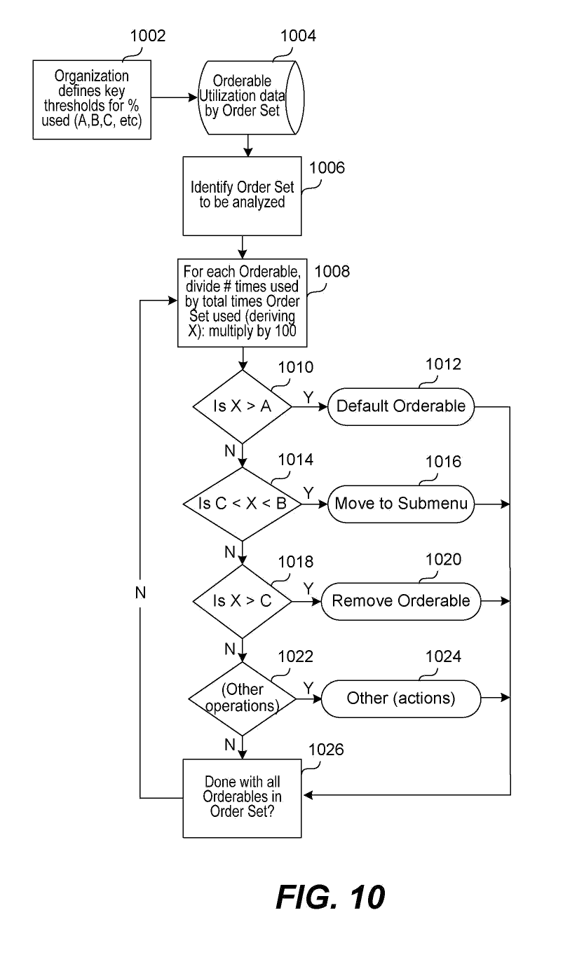

Below an example of automatic analysis based on these four variables is provided. This example describes one embodiment of automatic analysis, referred to as Autoanalysis with Integrated Feedback. In Autoanalysis, the System look at how often individual Orderables within an Order Set is used. The system then makes recommendations based on the actual utilization and utilization parameters, specifically percentages, set by the hospital. Three examples of how utilization percentages can drive autoanalysis are described. In one, referred to as Default selection of an Orderable, occurs if an orderable is used more than 90% of the time across all physicians. In this case the Orderable is prechecked and moved to the top of the relevant section. In another, referred to as Removal, if an Orderable is used less than 5% of the time across all physicians, the Orderable is removed from the Order Set. In the third, Downgrade, an Orderable that is used less than 20% of the time but greater than 5% across all physicians, the Orderable is moved to a dropdown menu section (e.g., “Other Orders”). This process is described in greater detail in FIG. 10.

Along with the analysis and recommendations above, the System also presents the subjective feedback captured from users about that Orderable, along with common variants where physicians changed the original Orderable to a new value. Using this autoanalysis feature, hospital administrators can improve the usability and specificity of their content (e.g. Order Set Library) based on both objective data from clinical practice along with subjective data from physicians. From within the same System, hospital staff can choose to implement the recommendations or make their own modifications to Order Sets, Orderables or Quality Measures as appropriate. This returns the cycle to the beginning, that is, to step 104 where delivery processes take place, thus completing the closed-loop process.

FIG. 10 is a flow diagram of a method of “autoanalysis” of an Order Set by Orderable in accordance with one embodiment of the present invention. Before the process begins, at step 1002, the hospital defines key orderable utilization thresholds and corresponding actions to be taken when thresholds are met. Using the example from above, these thresholds may be 90% (A), 20% (B), and 5% (C). This may be done once and maintained until the hospital believes further adjustments are needed. The hospital may also define more or fewer such threshold percentages. At step 1004 this data is stored with Orderable utilization data (by Order Set) or is stored in a memory accessible by the same system. At step 1006 the system identifies the Order Set to be analyzed. This selection may have been made, for example, by the hospital administrator.

At step 1008, the system examines usage of one Orderable. Specifically, for that Orderable, it determines the total number of times the Orderable has been selected or used by all physicians and divides this number by the total number of times the Order Set (in which the Orderable is contained) has been used. For example, if the Orderable has been used 27 times and the Order Set has been used 184 times (by all Physicians) for a particular time, it will divide 27 by 184, which equals 0.146. This number is then multiplied by 100 to obtain a percentage, in this case, 14.6%. This percentage value, X, is then used in subsequent steps.

At step 1010 the percentage value X is compared to one of the utilization threshold percentages, such as threshold A. If X is greater than A, the Orderable is selected as a default by the system at step 1012 (i.e., it is pre-checked). If X is not greater than A, control goes to step 1014 where the system determines whether X is greater than C and less than B (e.g., is it greater than 5% but less than 20%), in which case it is moved to a submenu or pull down menu at step 1016. This menu may be accessible, for example, by clicking a “+” sign in the Custom Order Set. If X is not within this range, control goes to step 1018 where the system determines if X is less than C. If it is, which implies that few physicians are using this Orderable, control goes to step 1020 where the Orderable is removed from the Order Set. Other operations or comparisons may be performed using X and other utilization thresholds indicated by step 1022 and step 1024 representing other actions that the system may take with respect to the Orderable. If no other operations take place or after the actions of steps 1012, 1016, 1020, and 1024, control goes to step 1026 where the system determines whether all the Orderables in the Order Set have been examined. If not, control returns to step 1008 where the utilization percentage of the next Orderable is determined.

### Computer System Embodiment

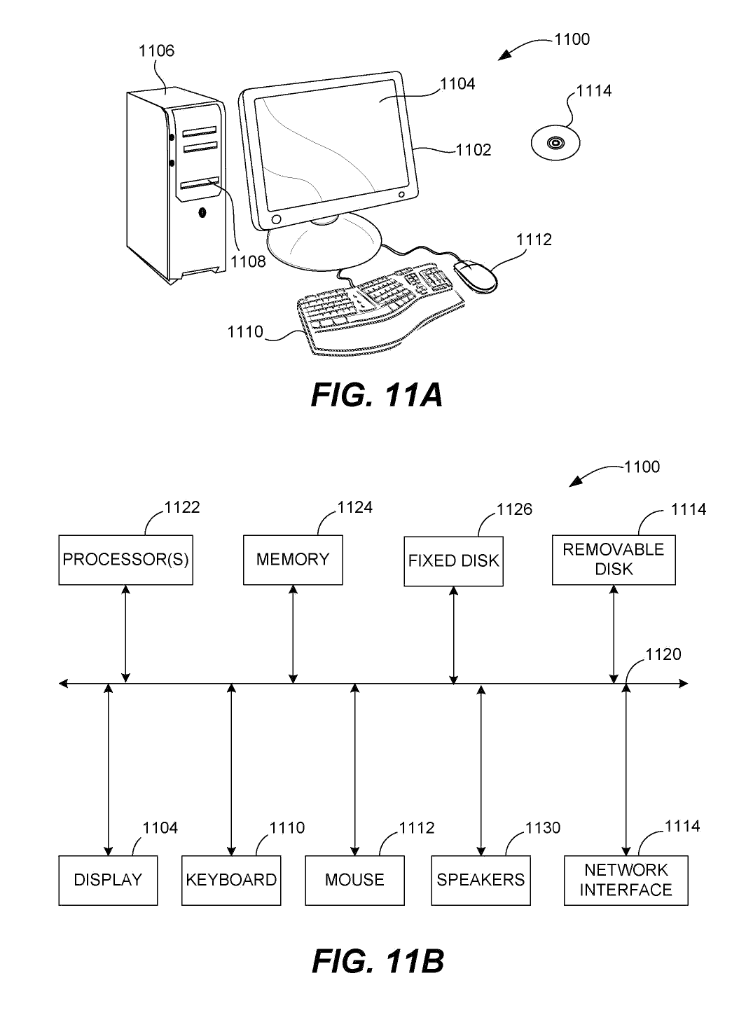

FIGS. 11A and 11B illustrate a computer system 1100 suitable for implementing embodiments of the present invention. As described above, the Physician, clinician, or hospital administrator, IT professionals at hospitals and clinics, among others, may enter and use the System via any type of suitable computing device, including desktop computers, laptops, netbooks, mini laptops, smart handset devices, handheld or mobile computing devices, cell phones, tablet computers, Internet appliances, integrated circuits, a printed circuit board, among others. FIG. 11A shows one possible physical form of the computer system. Computer system 1100 includes a monitor 1102, a display 1104, a housing 1106, a disk drive 1108, a keyboard 1110 and a mouse 1112. Disk 1114 is a computer-readable medium used to transfer data to and from computer system 1100.

FIG. 11B is an example of a block diagram for computer system 1100. Attached to system bus 1120 are a wide variety of subsystems. Processor(s) 1122 (also referred to as central processing units, or CPUs) are coupled to storage devices including memory 1124. Memory 1124 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 1126 is also coupled bi-directionally to CPU 1122; it provides additional data storage capacity and may also include any of the computer-readable media described below. Fixed disk 1126 may be used to store programs, data and the like and is typically a secondary storage medium (such as a hard disk) that is slower than primary storage. It will be appreciated that the information retained within fixed disk 1126, may, in appropriate cases, be incorporated in standard fashion as virtual memory in memory 1124. Removable disk 1114 may take the form of any of the computer-readable media described below.

CPU 1122 is also coupled to a variety of input/output devices such as display 1104, keyboard 1110, mouse 1112 and speakers 1130. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 1122 optionally may be coupled to another computer or telecommunications network using network interface 1140. With such a network interface, it is contemplated that the CPU might receive information from the network, or might output information to the network in the course of performing the above-described method steps. Furthermore, method embodiments of the present invention may execute solely upon CPU 1122 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

Although the foregoing invention has been described in some detail for purposes of clarity of understanding, it will be apparent that certain changes and modifications may be practiced within the scope of the appended claims. Therefore, the described embodiments should be taken as illustrative and not restrictive, and the invention should not be limited to the details given herein but should be defined by the following claims and their full scope of equivalents.

I claim:

1. A method of creating a custom order set, the method comprising:
presenting a framework of order sets, wherein the order sets are grouped according to one or more categories, a category being an area relevant to a specialty;
receiving a selection of one or more order sets from the framework;
examining the one or more order sets to determine a specific sequence in which the one or more order sets are presented to a user; and
displaying the one or more order sets to the user in a custom order set having a plurality of visual markups, wherein the custom order set enables the user to view order sets in a more intuitive manner.

2. A method as recited in claim 1 further comprising:
deriving a framework using input from physicians, wherein the framework corresponds to a methodology used by physicians in the specialty and shows generally how clinical knowledge in the specialty can be organized.

3. A method as recited in claim 1 wherein examining the one or more order sets further comprises:
selecting orderables with a specific category;
identifying the framework for the specialty;
sorting the orderables by the framework;
removing duplicate orderables; and
adding visual markup to remaining orderables.

4. A method of updating an order set library, the method comprising:
creating an order set using pre-defined orderables, new orderables, or both;
submitting the order set to an approval entity; and
receiving either an approval for enterprise-wise usage wherein the order set library is updated, an approval for use by an order set creator only, or a rejection.

5. A method of automatically modifying an order set, the method comprising:
identifying an order set to be analyzed;
for a specific orderable in the order set, determining a number of times the specific orderable has been used;
determining a number of times the order set has been used;
calculating a usage value of the specific orderable;
comparing the usage value to pre-defined threshold values;
modifying the order set with relation to the specific orderable based on the comparison, wherein the order set is modified without human intervention.

6. A method as recited in claim 5 wherein calculating a usage value further comprises:
dividing the number of times the specific orderable has been used by the total number of times the order set has been used, deriving a first value;
multiplying the first value by 100 to derive a utilization percentage value.
